(19) United States
(12) Patent Application Publication
(10) Pub. No.: US 2011/0272074 A1
(43) Pub. Date: Nov. 10, 2011

(54) Automatic Low Tire Inflation System (ALTIS)

(76) Inventor: Kenneth Arlen Lowery, Stow, OH (US)

(21) Appl. No.: 12/774,624

(22) Filed: May 5, 2010

(51) Int. Cl. B60C 23/04

(52) U.S. Cl. 152/418

(57) ABSTRACT

A method comprises enhancing current Tire Pressure Monitoring System (TPMS) functionality to result in inflation of a pneumatic tire if said tires fluid pressure decreases below a predetermined level. This embodiment comprises a pressurized container mounted inside a vehicle wheel that will react to a TPMS signal and release a fluid into the tire cavity, effectively increasing the inflation pressure.

### BACKGROUND OF THE INVENTION

Commencing with the vehicle model year 2008, the Transportation Recall Enhancement Accountability and Documentation (TREAD) act requires that all new vehicles sold in the United States warn an operator if any tire on the vehicle is 25% or more under-inflated. Most vehicle makers achieve this mandate by installing a fluid pressure and temperature sensor inside the tire cavity of a typical tire and rim assembly. The TPMS sensor then wirelessly communicates to an in-vehicle module that interprets and acts on the data The TREAD act accomplished its goal of warning a driver if a potential safety issue is present, however, this technology can be enhanced to also maintain the proper tire inflation amount.

Many studies have affirmed the importance of properly inflated pneumatic tires. A pamphlet produced by the National Highway Traffic Safety Administration (NHTSA) titled “Tire Safety, Everything Rides on It” states that properly inflated pneumatic tires improve vehicle handling (steering, stopping, traction and load carrying capacity), reduce breakdowns due to tire blowouts, improves fuel economy and increases the life of the tires. The NHTSA also found that under-inflated tires on a vehicle results in 300,000 vehicle accidents per year, 120 fatalities and 8500 injuries. The United States Department of Energy found that for every 1 pound of pressure below the recommended pounds per square inch (PSI) resulted in an increased use of 4 million gallons of gasoline, per day, in the United States. Each gallon of gasoline consumed produces 20.8 pounds of Carbon Dioxide (CO2) and thus the 4 million extra gallons consumed results in an additional 83.2 million pounds of CO2 released each day into the atmosphere.

A pneumatic tires inflation pressure can be affected in a number of ways:
1) The inflation or deflation of a tire cavity can be incorrectly performed.
2) A tire cavity loses 1 PSI of pressure, per month, due to air molecules permeating thru the tire.
3) A tire cavity loses 1 PSI per 10-degree drop in ambient air temperature. Consumers are advised to check their tires PSI once a month, but a rapid decrease in air temperature can make this maintenance inadequate.

Although many studies clearly show the benefit of proper pneumatic tire inflation, most consumers do not adequately maintain their tires pressure. A study by the Department of Transportation (DOT) determined that 85% of consumers were concerned with their tires pressure, but only 25% use the correct method to determine the recommended PSI and 43% ignore their tire pressure maintenance. A DOT survey found that 80% of light vehicles had 1 or more significantly under-inflated tires. It is also difficult or impossible to visually judge the tire pressure in a radial pneumatic tire.

There has been prior art to control a tires pressure, but each method was significantly complex and costly. This embodiment is a simple and cost-effective method that requires no tire, rim or valve stem modifications. Since this embodiment is contained entirely within a vehicle wheel, there is no additional liability or negative consequences due to the failure of this embodiment.

### SUMMARY OF THE INVENTION

A cost-effective method to insure a pneumatic tires PSI does not fall below a predetermined level. Although over-inflation has some drawbacks, an under-inflated tire is a significantly more serious problem. Current TPMS systems merely warn a consumer if any of the vehicle wheels tire cavity pressure falls below 25% of a preferred PSI level. This invention will utilize the pressure and temperature readings from the TPMS to determine when to add PSI to an under-inflated tire. This embodiment will also result in a significant safety advantage due to the ability to add fluid to a punctured tire, thereby decreasing the chance of a tire-blowout and increasing the amount of time for an operator to react to a pressure loss.

### BRIEF DESCRIPTION OF THE DRAWINGS

The drawings consist of vehicle wheel FIGS. 1 thru 3 and decision flowchart FIGS. 4 and 5.

Vehicle wheel FIGS. 1 thru 3 are similar in that a TPMS module determines when a tire is under-inflated and sends a signal to a solenoid attached to 1 of 3 fluid storage methods. The vehicle wheel figures only difference is in how the pressurized fluid is contained. All of the vehicle wheel figures utilize the same numeral denotations:
1) Denotes any pneumatic tire.
2) Denotes any metallic vehicle rim, which supports and seals a pneumatic tire creating a tire cavity.
3) Denotes any tire valve stem, which contains a valve to add/subtract fluid.
4) Denotes any TPMS module, which measures tire pressure and temperature.
5) Denotes any copper wire, encased in plastic, which carries a positive charge.
6) Denotes any copper wire, encased in plastic, which carries a negative charge.
7) Denotes a solenoid that reacts to a positive/negative polarity or a wireless communication.

Each of the vehicle wheel FIGS. 1 thru 3 are a representation of a different pressurized fluid container, denoted by a letter:
FIG. 1 contains letter A to denote pressurized fluid contained in a metal or plastic storage cylinder.
FIG. 2 contains letter B to denote pressurized fluid contained in a rubber-like inner tube.
FIG. 3 contains letter C to denote pressurized fluid contained in a metallic storage tank welded to a metallic rim.

The next 2 figures are decision flowcharts.
FIG. 4 describes the decision logic used to determine when to increase a pneumatic tires inflation pressure.
FIG. 5 describes when to communicate a message or warning to the vehicle operator.

### DETAILED DESCRIPTION OF THE DRAWINGS

The vehicle wheel FIGS. 1 thru 3 denote a similar art. A TPMS module senses a tires pressure (denoted by 30 PSI) and temperature and systematically determines if a tire is under-inflated. The TPMS module then sends an electrical current thru a pair of copper wires, or communicates wirelessly, to actuate a solenoid, which is attached to one of 3 types of pressurized fluid containers (denoted by 125 PSI). The pressurized fluid container has a pressure many times greater than the pressure found in the tire cavity. The fluid contents are then released into the tire cavity thereby effectively increasing the tires PSI.

It has yet to be determined which of the 3 container methods is the most practical. The current embodiment is simply the communication between a TPMS sensor and a pressurized container. Each of the 3 types of containers has advantages and disadvantages and all 3 will be evaluated to determine which is the most efficient and cost-effective.

FIG. 1 of the drawings is a frontal view of a typical vehicle wheel assembly. The pressurized fluid container consists of a metal or plastic cylinder that is capped on both ends and contains a standard tire valve on one end to allow the entry or release of fluid. The container is banded to the wheel with a metal strap to restrict movement within the tire cavity. While performing a tire and rim assembly, a tire technician will band the container to the rim.

FIG. 2 of the drawings is a cross-section of a typical vehicle wheel assembly. The pressurized fluid container consists of a tire inner tube, complete with a tire valve stem, found on most bicycles and some vehicles. The inner tube is stretched over the wheel by a tire technician and when inflated will hug the inside diameter of the wheel.

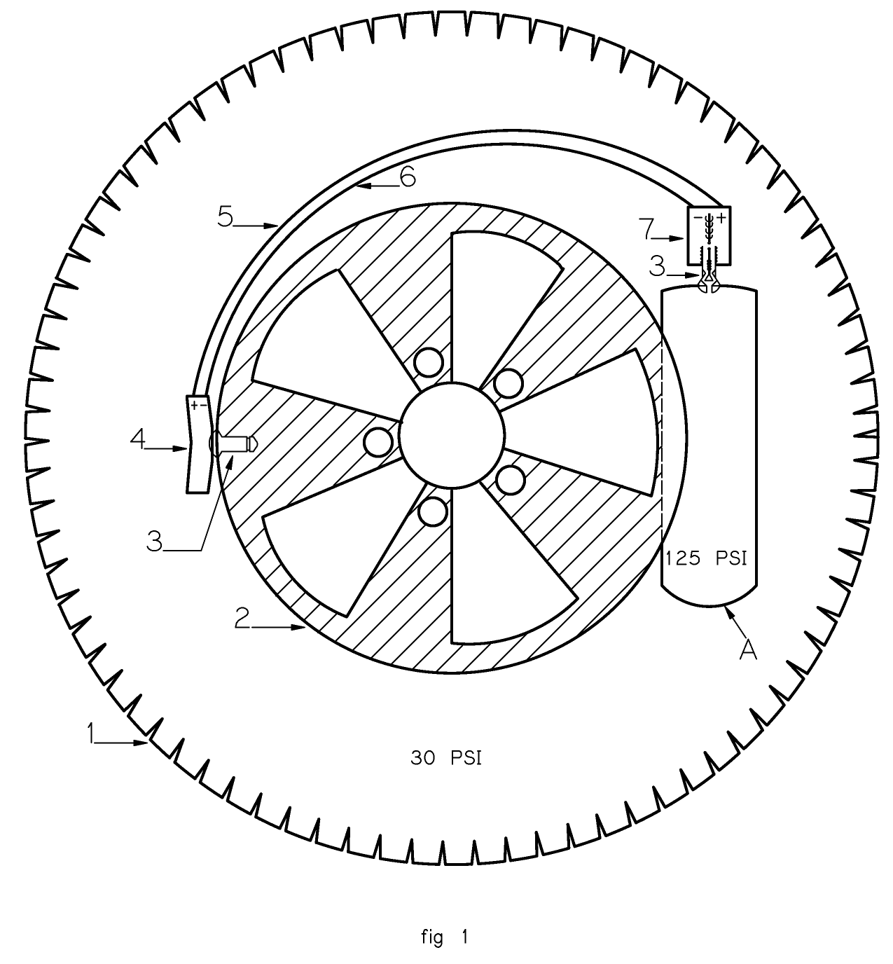

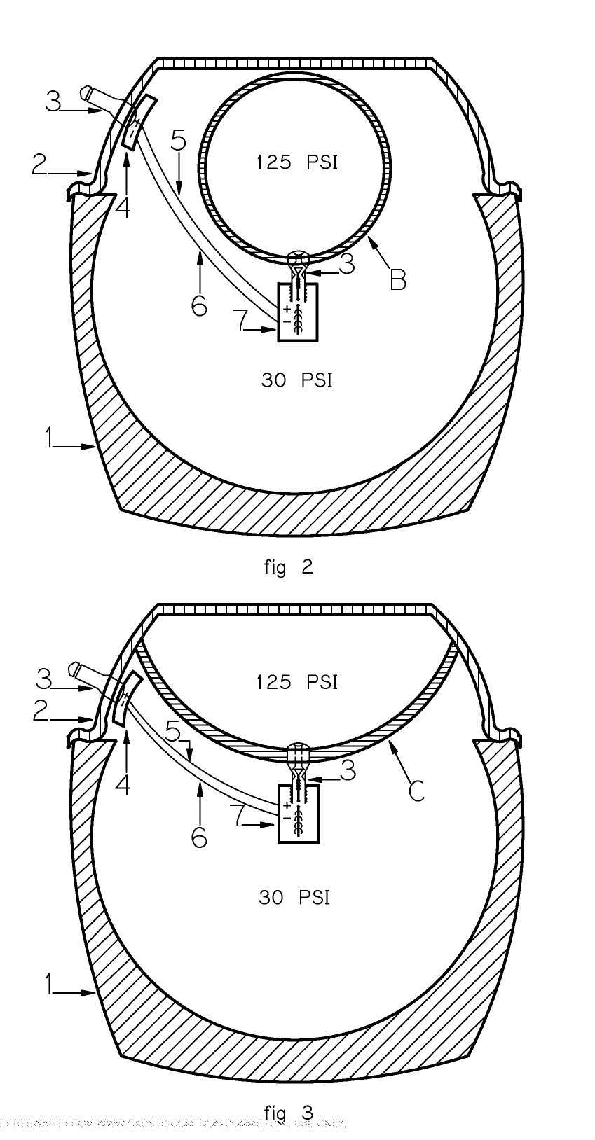

FIG. 3 of the drawings is a cross-section of a typical vehicle wheel assembly. The pressurized fluid container consists of a metal cavity welded around the inside diameter of a rim. The welding will occur during the rims manufacturing. The container will have a hole thru which a tire valve stem is inserted and anchored at the factory and/or by a tire technician.

After the installation of one of the 3 pressurized containers, the technician would then:
1) Inflate the container to a recommended PSI (125 in this embodiment).
2) Attach the solenoid to the tire valve stems threaded end using a rotational method.
3) If wired, attach the positive copper wire from the positive lead on the solenoid to the positive lead on the TPMS module.
4) If wired, attach the negative copper wire from the negative lead on the solenoid to the negative lead on the TPMS module.
5) Install the tire onto the rim.
6) Inflate the tire to the recommended PSI thru the tire valve stem, which is attached to the rim.

FIG. 4 is a flowchart of the decision logic to be used by the TPMS transmitter mounted inside the tire cavity. To conserve power, the transmitter is in a wait/sleep state until it senses a rotational force. The transmitter polls the pressure and temperature sensors to retrieve a numerical value. The data is wirelessly transmitted to the on-board TPMS receiver. The transmitter returns to the wait/sleep cycle for a number of seconds. The transmitter awakens and re-polls the pressure and temperature sensors and wirelessly transmits to the on-board receiver. The transmitter then determines if the pressure at the current temperature is less than a minimum amount in PSI increments. If the pressure is satisfactory, the transmitter returns to the wait/sleep cycle. If the pressure is below the minimum amount, the transmitter will send a current or wirelessly communicate to the solenoid mounted on a pressurized container and continue the current until the optimal pressure is obtained up to a maximum of 5 PSI (to reduce the chance of over-inflation). The transmitter then reports the amount of PSI added to the on-board receiver.

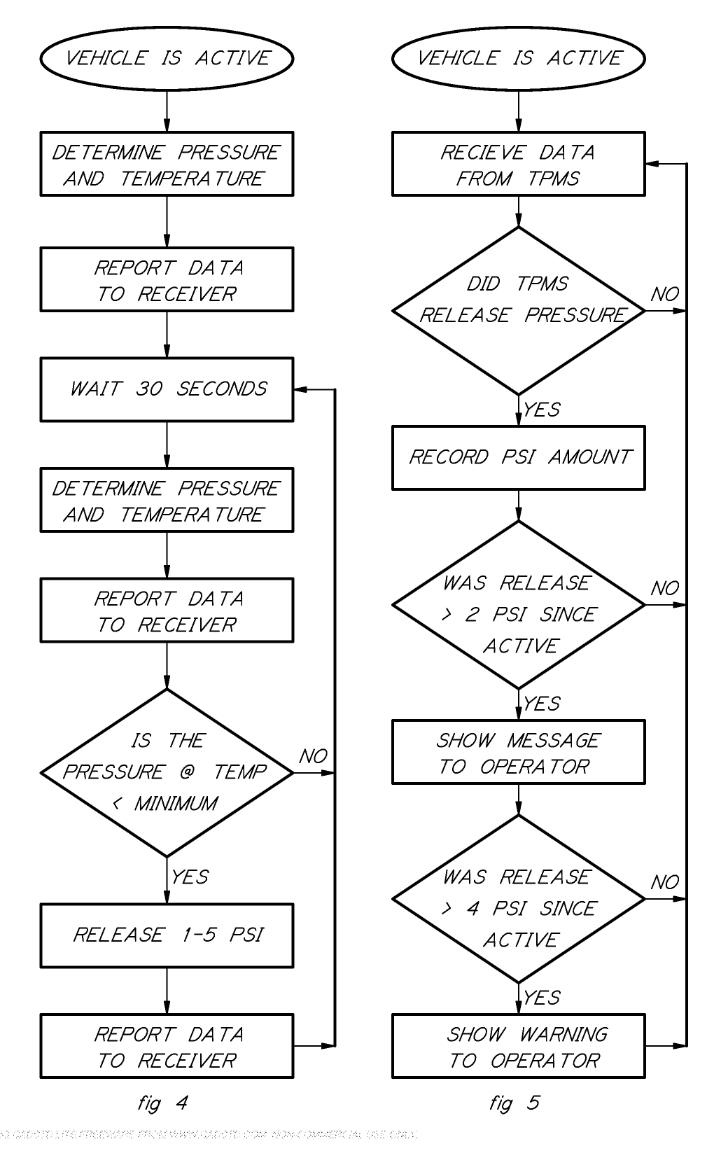

FIG. 5 is a flowchart of the decision logic to be used by the on-board TPMS receiver. Whenever the vehicle is in a run condition, the receiver is ready to accept transmissions from the TPMS transmitter. The receiver accepts the transmitter data and records the amount of PSI if pressure was released. If the cumulative release was more than 2 PSI, the receiver reports a message to the vehicle operator, “3 PSI WAS ADDED TO RF TIRE SINCE THIS VEHICLE WAS STARTED”. If the cumulative release was greater than 4 PSI, the receiver reports a warning to the vehicle operator, “A LEAK WAS DETECTED IN RF TIRE, PLEASE REMEDY THE SITUATION”. The receiver continues to monitor the transmitter and adds to the PSI total whenever a pressure release occurs. The total is reset whenever the vehicle is started.

I claim:

1. A self-contained tire pressure inflation system, comprising: a vehicle wheel comprising a tire and a rim, which when assembled create a tire cavity; a tire pressure monitoring system module mounted in the tire cavity; a pressurized fluid container mounted in the tire cavity; a fluid releasing solenoid attached to the pressurized fluid container; and a wired electrical or wireless communication between the tire pressure monitoring system module and the pressurized fluid container.

2. A self-contained tire pressure inflation system, as in claim 1, further comprising: a tire pressure monitoring system module that calculates the tire cavity fluid pressure and tire cavity temperature to determine when the tire cavity fluid pressure falls below a pre-determined level.

3. A self-contained tire pressure inflation system, as in claim 2, further comprising: a tire valve stem, mounted to the rim that allows for manual fluid inflation or deflation of the tire cavity and is the mounting location for the tire pressure monitoring system module.

4. A self-contained tire pressure inflation system, as in claim 1, further comprising: a pressurized fluid container that holds a fluid at a pressure many times greater than the tire cavity, that will be released to maintain the proper tire cavity inflation pressure.

5. A self-contained tire pressure inflation system, as in claim 4, further comprising 1 of 3 containers: a metallic cylinder capped on both ends, a rubber-like inner tube, or a welded to the rim metallic tank.

6. A self-contained tire pressure inflation system, as in claim 5, further comprising: a tire valve stem to seal the pressurized container and to allow a periodic release of the pressurized fluid.

7. A self-contained tire pressure inflation system, as in claim 1, further comprising: a pressure releasing solenoid that screws onto a tire valve stem and actuates in response to the tire pressure monitoring system modules electrical or wireless communication signal.

8. A self-contained tire pressure inflation system, as in claim 7, further comprising: an electronically actuated plunger that presses on the tire valve stem to release a pressurized fluid.

9. A self-contained tire pressure inflation system, as in claim 1, further comprising: a wired electrical or wireless communication to transmit an actuation signal from the tire pressure monitor system module to the pressure releasing solenoid.

10. A self-contained tire pressure inflation system, as in claim 9, if wired, further comprising: 2 copper wires, encased in plastic, one carrying a positive charge and the other a negative charge.

11. A self-contained tire pressure inflation system, as in claim 9, if wireless, further comprising: a receiver as part of the solenoid module which would receive a tire pressure monitors wireless signal and utilize a battery to actuate the solenoid plunger.
